(19) United States
(12) Patent Application Publication
(10) Pub. No.: US 2007/0003227 A1
(43) Pub. Date: Jan. 4, 2007

(54) Video display processing apparatus and method of checking recording/reproducing device provided in the video display processing apparatus

(75) Inventor: Yukio Mori, Fukaya-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/476,773

(22) Filed: Jun. 29, 2006

(30) Foreign Application Priority Data
Jun. 30, 2005 (JP) 2005-193146

(51) Int. Cl. H04N 7/00

(52) U.S. Cl. 386/95

(57) ABSTRACT

There are provided a reception section, a signal processing section, a display section, a recording/reproducing device, a checking section which subjects the recording/reproducing device to a check processing regarding factors, a management section which causes the recording/reproducing device to start recording/reproducing information or readies the recording/reproducing device to start recording/reproducing the information, a check waiting control section which makes the checking section wait for the check processing, when the recording/reproducing device starts to record/reproduce the information or readies to start recording/reproducing the information before the checking section starts the check processing, and a checking start control section which makes the checking section start the check processing, when the recording/reproducing device does not start to record/reproduce the information or ready to start recording/reproducing the information before the checking section starts the check processing.

### CROSS-REFERENCE TO RELATED APPLICATIONS

This application is based upon and claims the benefit of priority from Japanese Patent Application No. 2005-193146, filed Jun. 30, 2005, the entire contents of which are incorporated herein by reference.

### BACKGROUND

1. Field

An embodiment of the invention relates to a video display processing apparatus, and a checking device and method for checking a recording/reproducing device, and in particular a device and method for indicating, after checking the state of the recording/reproducing device, with an advance notice or alarm that the recording/reproducing device is likely to fail, before it actually does.

2. Description of the Related Art

As is well known, in recent years, digital broadcasting has advanced. For example, in Japan, terrestrial digital broadcasting has been started in addition to broadcasting satellite (BS) digital broadcasting and a 110-communication satellite (CS) broadcasting, etc.

Also, in recent years, television broadcast receivers have been made which can automatically record broadcasting programs based on a genre or keyword specified by the user, and enables the user to select and view a desired recorded broadcasting program.

Such a television broadcast receiver uses a recording/reproducing device having a large capacity for recording a number of programs, and an access function of quickly retrieving a desired program from those recorded, and then reproducing it. In order to satisfy such a requirement, the recording/reproducing device takes the form of a hard disk drive (HDD).

HDDs are very delicate, and easily affected by heat, impact and vibration. Thus, there is a possibility of HDD failure, in which it becomes impossible to record information in the HDD or reproduce information therefrom. Whether such a failure occurs or not depends on the condition under which the HDD is used, the age of the HDD, and the frequency of use of the HDD. Needless to say, when such a failure occurs, the HDD must be replaced.

As a countermeasure for the above problem, it has been disclosed that before the HDD can fail, it is checked, and the likelihood of failure estimated so that, if needs be, replacement can be suggested (as in, e.g., Jpn. Pat. Appln. KOKAI Publication No. 2004-342168). Further, magnetic disk devices having a checking function and a failure prediction function have been developed (as in, for example, Jpn. Pat. Appln. KOKAI Publication No. 2001-307435). In such a device, parameters such as the bit error rate, the number of times of start-up, and the seek function performance are checked periodically. When it is determined that there is a likelihood of the HDD failing, an alarm indicating this eventuality is issued to a host system. It has also been disclosed that the friction force between the head and the surface of the disk is measured to detect an abnormality (as in, e.g., Jpn. Pat. Appln. KOKAI Publication No. 07-085575).

Conventionally, various techniques regarding checking and failure anticipation for the HDD have been developed. However, they do not take full account of the relationship between the time at which the recording/reproducing processing of the HDD is carried out and the time at which the HDD is checked in advance.

### BRIEF SUMMARY OF THE INVENTION

The object of an embodiment of the present invention is to provide a video display processing apparatus using a recording/reproducing device (hard disk device) having a large capacity, and a checking device and a checking method, both for checking a recording/reproducing device, in which the recording/reproducing device is checked such that this checking does not interfere with the recording/reproducing operation of the recording/reproducing device.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary view showing an external appearance of the front side of a television broadcast receiver to which an embodiment of the present invention is applied.

FIG. 2 is an exemplary view showing a signal processing system of the television broadcast receiver.

FIG. 3 shows exemplary main structural elements of the embodiment.

FIG. 4 is a flowchart of an example of an operation of an apparatus according to the embodiment of the present invention.

FIG. 5 is a flowchart showing the outline of a method of checking an HDD in advance after it is determined in the flowchart of FIG. 4 that the HDD can be checked.

FIG. 6 is a flowchart of an example showing a method of informing the user in advance that the HDD is in an abnormal state, after the check processing for the HDD ends.

FIG. 7A shows an example of an image which is displayed by an OSD processing section in a step ST22 in FIG. 6.

FIG. 7B shows an example of an image which is displayed after a conventional HDD fails completely.

FIG. 8 is a flowchart of the outline of a method of performing a check processing on the HDD, according to another embodiment of the present invention.

FIG. 9 is a flowchart showing a method of informing the user of the result of the check processing for the HDD, which is shown in FIG. 8.

FIG. 10 is a view showing an example of an image displayed by the apparatus according to the embodiment of the invention.

FIG. 11 is a view showing an example of another image displayed by the apparatus according to the embodiment of the invention.

FIG. 12 is a view showing an example of a further image displayed by the apparatus according to the embodiment of the invention.

FIG. 13 is a view showing an example of a signal processing system of the television broadcast receiver.

### DETAILED DESCRIPTION

Various embodiments according to the invention will be described hereinafter with reference to the accompanying drawings. An embodiment of the present invention provides a reception section which receives a video signal; a signal processing section which subjects the video signal to a predetermined signal processing on the video signal; a video display section which displays video based on the video signal subjected to the predetermined signal processing; a recording/reproducing device which records as data an output signal from the signal processing section; an checking section which subjects the recording/reproducing device to a check processing with respect to a plurality of failure factors; a recording/reproducing management section which causes the recording/reproducing device to start recording/reproducing information or readies the recording/reproducing device to start recording/reproducing the information; a checking control section which causes the checking section to wait for the check processing, when the recording/reproducing management section causes the recording/reproducing device to start recording/reproducing the information or readies the recording/reproducing device to start recording/reproducing the information before the checking section starts to perform the check processing; an checking start control section which causes the checking section to start the check processing when the recording/reproducing management section does not cause the recording/reproducing device to start recording/reproducing the information or ready the recording/reproducing device to start recording/reproducing the information before the checking section starts the check processing; and a check result indication section which causes the video display section to display the result of the check processing.

In the above structure, a check waiting control section and the checking start control section monitor whether the recording/reproducing device is in a recording/reproducing ready state in which it readies to start recording/reproducing the information or a recording/reproducing start state in which it starts to record/reproduce the information. Thus, the recording/reproducing device can be checked at an appropriate timing. Therefore, such a check processing does not interfere with the operation.

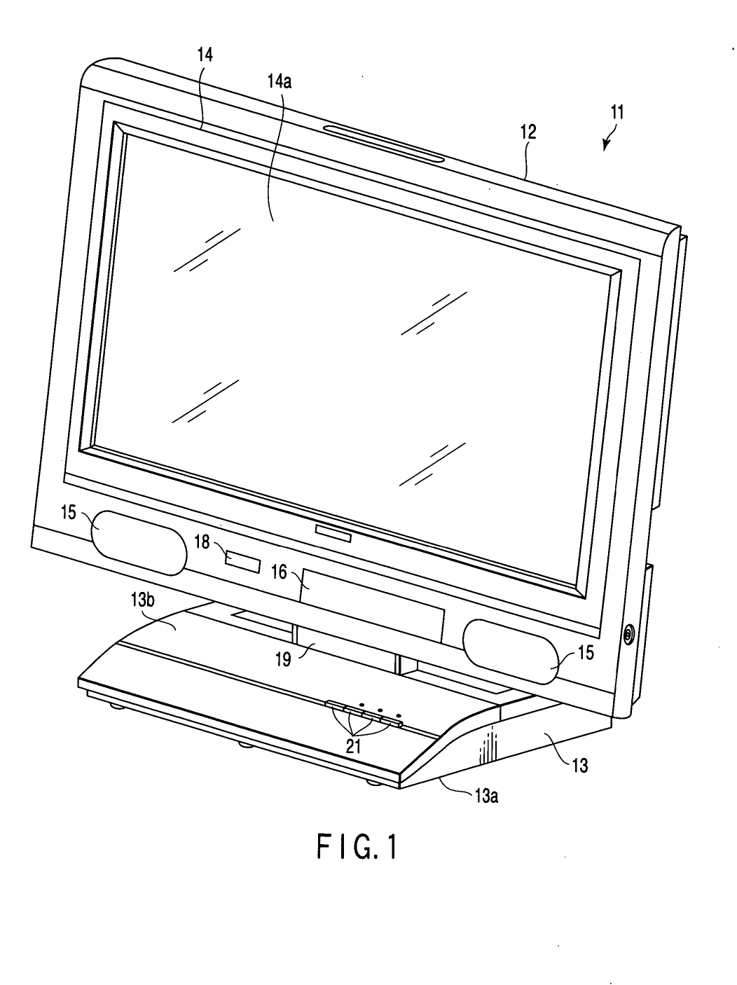

FIG. 1 shows an external appearance of the front side of a television broadcast receiver 11 to which the above embodiment of the present invention is applied.

As shown in FIG. 1, the television broadcast receiver 11 comprises, as main portions, a thin main body 12 which includes a cabinet, and is substantially rectangular, and a stand 13 which supports the main body 12 while keeping it upright.

On the front side of the above main body 12, a display screen 14a of a video display 14 such as a flat liquid crystal display panel is exposed, and a pair of speakers 15, an operation portion 16 and a photoreceiver 18, etc. are arranged. The photoreceiver is provided to receive operation information sent from a remote control (not shown in FIG. 1) which will be described later.

The stand 13 is formed substantially in the shape of a thin box, and a flat bottom plate 13a of the stand 13 is placed on a predetermined base (not shown) horizontally set. Furthermore, in the stand 13, a support member 19 is provided to project upwardly from a substantially center portion of an upper plate 13b which is located opposite to the bottom plate 13a on the base, whereby the stand 13 supports the main body 12 while keeping it upright.

The stand 13 can accommodate an HDD 20 (not shown in FIG. 1) which will be described later. On part of the upper plate 13b of the stand 13, which projects forwardly with respect to the main body 12 as viewed from above, a plurality of operation buttons 21 are arranged (i.e., in the receiver shown in FIG. 1, four operation buttons 21 are arranged). The operation buttons 21 can be pressed to control the HDD 20; that is, they are pressed to cause the HDD 20 to perform a recording/reproducing processing and stop the operation of the HDD 20.

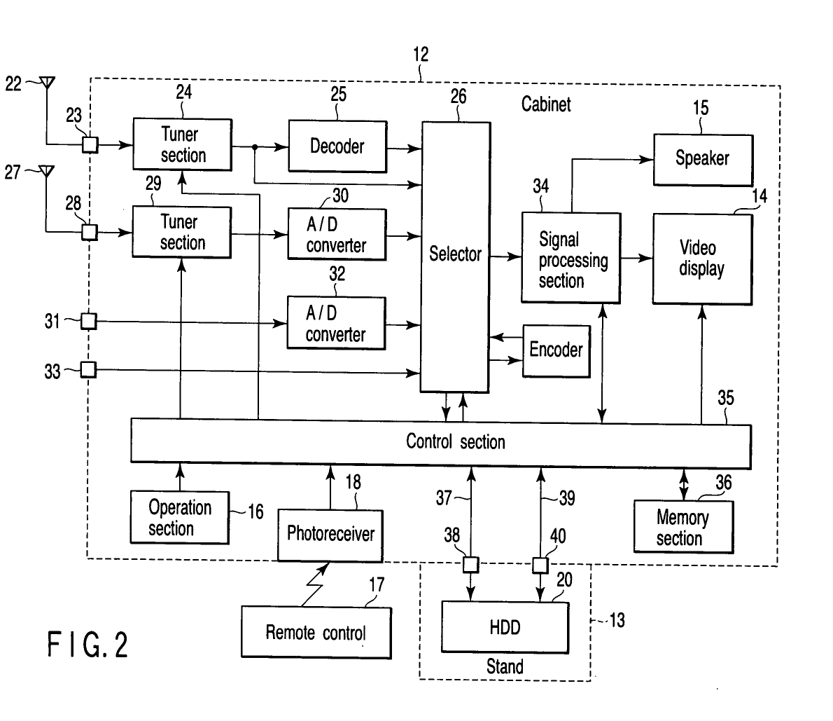

FIG. 2 diagrammatically shows a signal processing system of the television broadcast receiver 11. Various circuits included in the signal processing system are arranged mainly close to an inner rear surface of the main body 12, i.e., in the vicinity of the reverse side of the display screen 14a of the video display 14. In the signal processing system, a digital television broadcast signal received by an antenna for television broadcast is supplied to a tuner section 24 through an input terminal 23. The tuner section 24 selects a signal of a desired channel from the digital television broadcast signal, and demodulates the selected signal. The signal output from the tuner section 24 is supplied to a decoder 25, and is then supplied to a selector 26 after being subjected to, e.g., a Moving Picture Experts Group Standard 2 (MPEG-2) decode processing.

The output of the tuner section 24 is directly supplied to the selector 26. For example, video/audio information can be extracted from the output of the tuner section 24, and be recorded in the HDD 20 through a control section 35.

Furthermore, an analog television broadcast signal received by an antenna 27 for analog television broadcast is supplied to a tuner section 29 through an input terminal 28. The tuner section 29 selects a signal of a desired channel from the analog television broadcast signal, and demodulates the selected signal. The signal output from the tuner section 29 is supplied to the selector 26 after being digitized by an analog-to-digital (A/D) converter 30.

Moreover, an analog video/audio signal supplied to an input terminal 31 for analog signal is output to an A/D converter 32, and is digitized thereby. It is then output to the selector 26. A digital video/audio signal supplied to an input terminal 33 for digital signal is output to the selector as it is.

In the case where the signal subjected to A/D conversion is recorded in the HDD 20, it is done after being subjected to a compression processing complying with a predetermined format, e.g., MPEG-2.

The selector 26 selects one of four kinds of digital video/audio signals input to the selector 26, and supplies it to a signal processing section 34.

The signal processing section 34 performs a predetermined signal processing on the signal supplied to the signal processing section 34 in order for the video display 14 to display video based on the signal. As the video display 24, for example, a flat-panel liquid crystal display or a flat-panel plasma display is adopted. In addition, the signal processing section 34 converts a digital audio signal supplied thereto into an analog audio signal by carrying out a predetermined signal processing, and outputs it to the speakers 15, in order that audio content be reproduced from the speakers 15.

Various operations of the television broadcast receiver 11, which include the above receiving operations, are subject to centralized control by the control section 35. The control section 35 is a microprocessor incorporating a central processing unit (CPU), etc. It receives operation information from the above operation section 16 or operation buttons 21 (not shown in FIG. 2), or operation information sent from the remote control 17 through the photoreceiver 18, and controls a plurality of sections based on the operation information.

In this case, the control section 35 uses the memory section 36. The memory section 36 comprises, as main elements, a read-only memory (ROM) storing a control program to be executed by the CPU, a random access memory (RAM) which provides an operation area to the CPU, and a nonvolatile memory storing a plurality of kinds of set information and control information, etc.

The control section 35 is connected to the HDD 20 provided in the stand 13. In this case, a line 37 for use in supplying power and a control signal from the control section 35 to the HDD 20 connects the control section 35 and the HDD 20 through a control section 38.

A line 39 for transmitting a digital video signal and a digital audio signal between the control section 35 and the HDD 20 connects the control section 35 and the HDD 20 through an i.Link connection section 40. That is, transmission of the digital video signal and digital audio signal through the i.Link is performed separately from supplying of power and control signal.

The television broadcast receiver 11 can record the digital video and audio signals selected by the selector 26 by using the HDD 20, and reproduce the digital video and audio signals recorded in the HDD 20 to provide video and audio content.

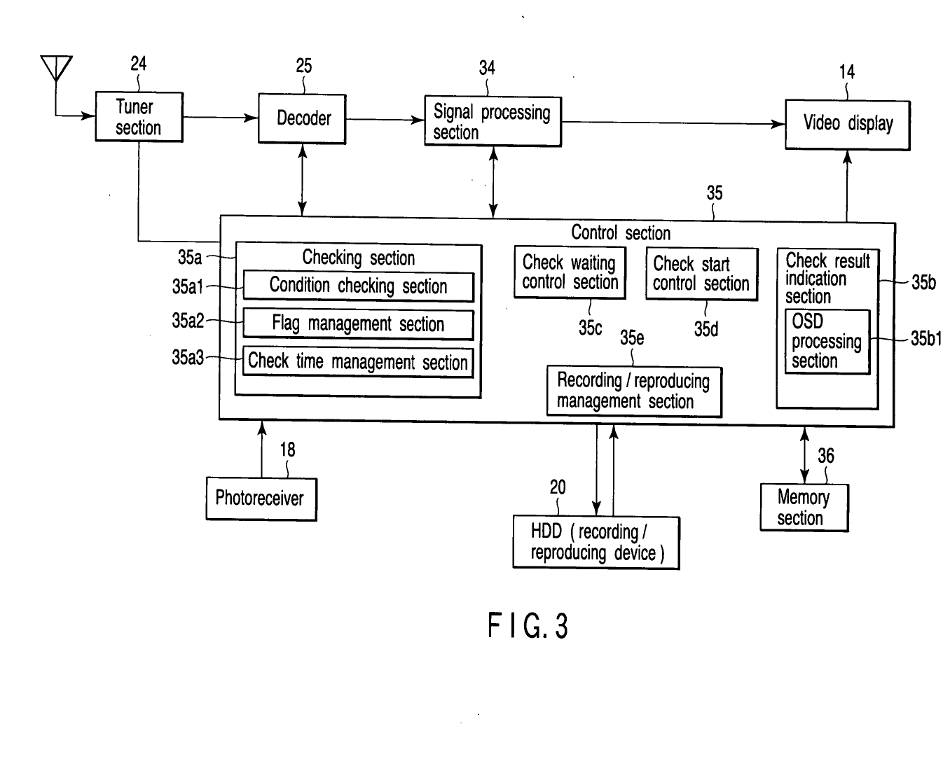

FIG. 3 shows main structural elements of the present invention. As shown in FIG. 3, the control section 35 comprises a checking section 35a and the recording/reproducing management section 35e. The checking section 35a performs a check processing on the HDD (which can be also referred to as a recording/reproducing device) 20 with respect to a plurality of failure factors. The check processing will be described later. The recording/reproducing management section 35e causes the recording/reproducing device 20 to start recording/reproducing the information or readies the recording/reproducing device 20 to start recording/reproducing the information. Further, the control section 35 includes a check waiting control section 35c which causes the checking section 35a to enter a check waiting state in which it waits for the check processing, i.e., it does not check the HDD 20, when the recording/reproducing management section 35e causes the recording/reproducing device 20 to start recording/reproducing the information (information record or reproduction start operation) or readies the recording/reproducing device 20 to start recording/reproducing the information (information record or reproduction start ready operation) before the checking section 35e starts the check processing.

The above information record start operation of the recording/reproducing management section 35e means that it actually starts recording the information. The information record or reproduction start ready operation includes the following states: the power supply is turned on for timer recording operation; the set time for timer recording operation approaches, for example, five minutes before the set time; and the power supply is turned on in response to an operation signal for video recording. It should be noted that turning on of the power supply means that a main power supply is turned on to enable the recording/reproducing device to carry out all operations; that is, it does not include a waiting power supply state in which for example, an initial response can be made in accordance with a remote control operation.

The information reproduction start operation of the recording/reproducing management section 35e means that it actually starts reproducing the information. The information reproduction start ready operation includes a state in which the power supply is turned on for reproduction.

The control section 35 further comprises an checking start control section 35d which causes the checking section 35e to start the check processing, when the recording/reproducing management section 35e does not start record/reproduce the information or ready to record/reproduce the information before the checking section starts the check processing.

Furthermore, the checking section 35a includes a condition checking section 35a1, a flag management section 35a2 and a check time management section 35a3. Their operations and functions will be described later.

The check result indication section 35b includes an on-screen display (OSD) processing section 35b1.

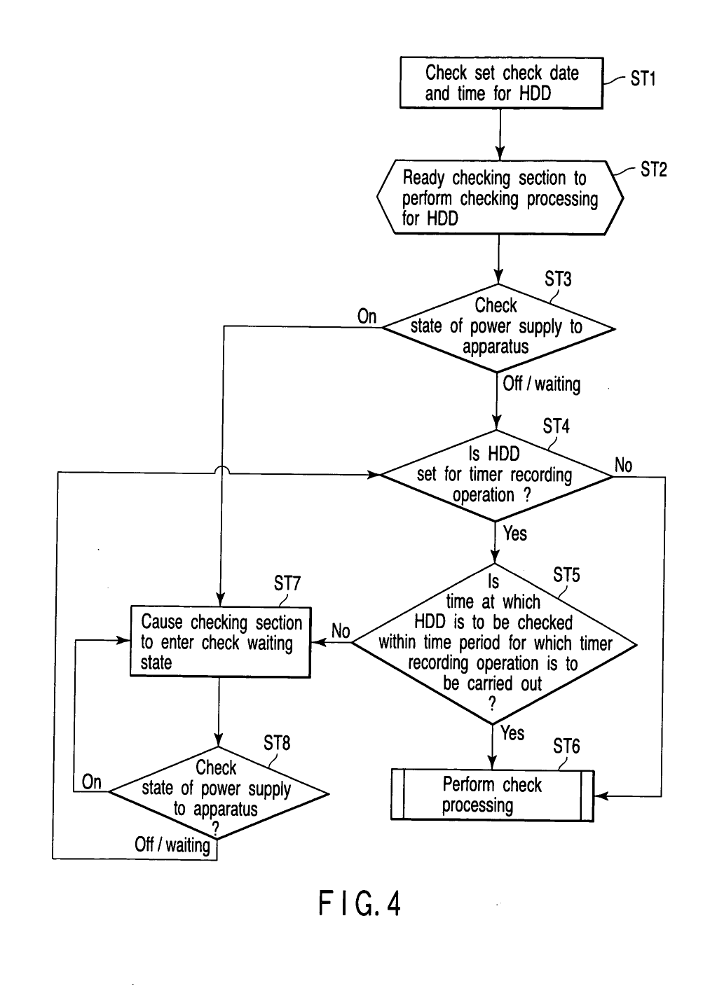

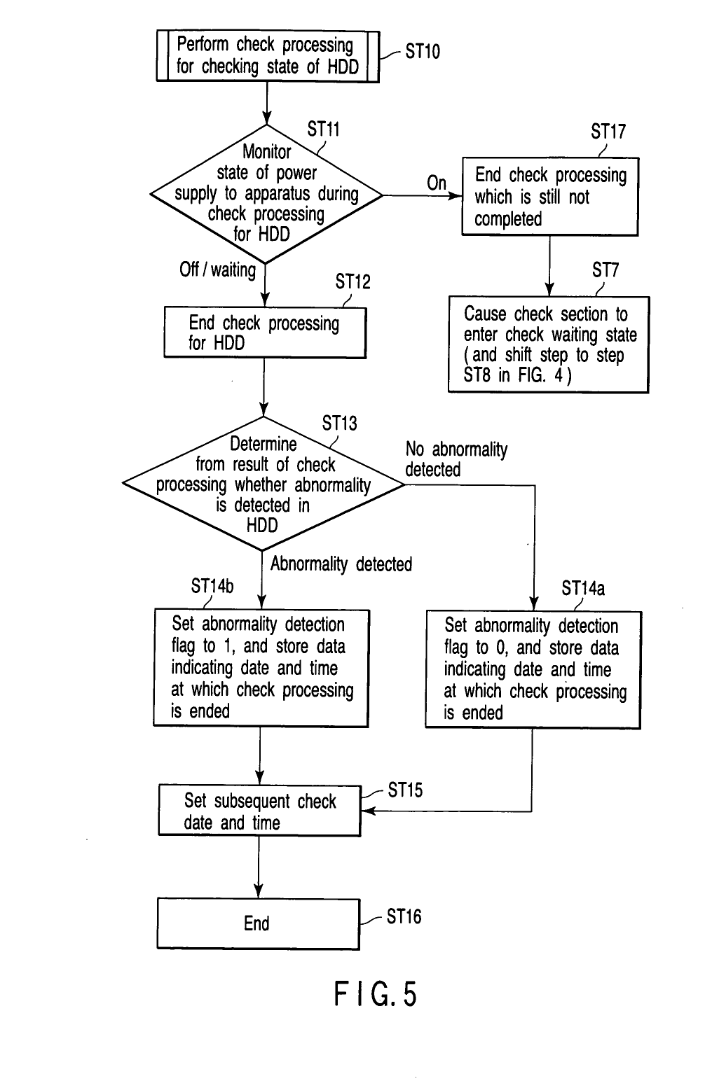

FIG. 4 is a flowchart of an example of an operation of the apparatus according to the above embodiment of the present invention. Suppose the HDD 20 is registered as an element to be checked by the checking section 35a. For example, in the checking section 35a, the date and time at which checking is to be carried out is set as check date and time. As the method of setting the check date and time, various methods can be applied. For example, it is set such that the checking is carried out at regular intervals, or the date and time at which a predetermined time lapses after the final check date and time is set as the check date and time.

The checking section 35a checks whether the present time corresponds to the set check date and time (step ST1). This checking is managed by, e.g., the check time management section 35a3. When the present time is corresponds to the set check date and time or the check date and time passes away, the checking section 35a readies to perform the check processing (step ST2), and it is determined whether the power supply to an apparatus (digital television receiver or recorder) is in the ON state or OFF state (step ST3).

When the power supply to the apparatus is in the ON state, the HDD 20 starts to record/reproduce the information, or readies to start recording/reproducing of the information as the time for the timer recording operation approaches. In such a case, the checking section 35a enters the check waiting state (step ST7). In this state, the state of the power supply to the apparatus is further monitored (step ST8). When it is detected that the power supply to the apparatus is turned off, it is checked whether the HDD 20 is set for timer recording operation (step ST4). In the step ST3, also in the case where the power supply to the apparatus is in the OFF state, the step to be carried out proceeds to the step ST4.

In the step ST4, when it is determined that the HDD 20 is not set for timer recording operation, the processing to be carried out is shifted to the check processing for the HDD (step ST6). On the other hand, in the step ST4, when it is determined that the HDD 20 is set for timer recording operation, it is checked whether the present time is within the time period for which timer recording operation is to be carried out (in the HDD 20), i.e., time at which the HDD 20 is to be carried out is within the above time period (step ST5).

In the step ST5, when it is determined that the present time is not within the time period for which the timer recording operation is to be carried out, the step to be carried out proceeds to the step ST6, and the checking section 35a checks the HDD 20. When it is determined that the present time is within the above time period, and the checking section 35a enters the check waiting state.

As described above, it is necessary to periodically check the HDD 20. In this checking, a subsequent date and time at which the HDD 20 is to be checked is stored as data in advance in the nonvolatile memory, etc. in the apparatus based on the date and time at which the HDD 20 was checked (this processing corresponds to a step ST15 which will be described later).

As explained above, in the case where the power supply to the apparatus is in the ON state, it can be considered that the recording/reproducing processing has already been carried out. Furthermore, in an apparatus incorporating the digital broadcast receiver, there is a case where when the power supply is turned on, a high-definition television broadcast is subjected to decode processing, and it is thus assumed that the load on the CPU in a recorder of the apparatus is high, or the performance is lowered. Therefore, the check processing for the HDD 20 is prevented from being performed in parallel with the above processings.

It should be noted that when the power supply is in OFF or waiting state, it means that power is supplied only in order to control a microcomputer for use in controlling a minimum set of elements, and when the power supply is in the ON state, it means that the user can operate various functions of the apparatus.

FIG. 5 is a flowchart showing the outline of a method of checking the HDD 20 in advance with respect to whether the HDD 20 is likely to fail or not, after it is determined in the flowchart of FIG. 4 that the check processing for the HDD 20 can be executed.

In a step ST10, the check processing for checking the state of the HDD 20 is started. Although the present application does not define specific means for checking the HDD 20 in advance, use of a Self-Monitoring, Analysis, and Reporting Technology (SMART) function will be explained by way of example.

The SMART function has a number of parameters for determining by estimation whether the HDD is likely to fail or not. That is, it can determine by estimation whether HDD failure is likely to occur or not, by reading the parameters.

For example, as the parameters, the following parameters are provided: the total power-on time, i.e., the total time for which the power supply is in the ON state (driving cumulative time); temperature; Contact Start Stop (CSS) frequency; the number of times retry is carried out; the number of abnormal sectors; and Read/Write error rate, etc. For example, the life of the HDD can be estimated from the temperature and the total power-on time. Also, the possibility with which the HDD is likely to fail can be determined by estimation from the number of retry operations carried out, the number of bad sectors, and the Read/Write error rate.

As described above, the HDD is checked under the condition wherein the power supply to the apparatus is in the OFF or waiting state. Thus, while the state of the HDD 20 is being checked in the step ST10, the state of the power supply to the apparatus is continuously monitored (step ST11).

When the power supply to the apparatus is turned on during the check processing for checking the HDD 20, the step to be carried out proceeds to a step ST17 to end the check processing for the HDD 20. In this case, since the check processing for the HDD 20 is incomplete, the step to be carried out is shifted to the step ST7 disclosed in FIG. 4, and the checking section 35a enters the check waiting state.

During the check processing for the HDD 20, when the power supply to the apparatus is continuously in the OFF state or waiting state, and the check processing is normally completed, the check processing is ended in the step ST12, and the step to be carried out proceeds to the step ST13. In the step ST13, it is determined whether an abnormality is detected in the HDD 20 or not. When it is determined that an abnormality is detected, the step to be carried out proceeds to a step ST14b, and when it is determined that no abnormality is detected, the step proceeds to a step ST14a.

In the step ST14a, an abnormality detection flag is set to 1, a check end date and time, i.e., the date and time at which checking is ended, is stored as data, and the step proceeds to a step ST15. In the step STb, the abnormality detection flag is set to 0, and the check end date and time is stored as data, and the step proceeds to the step ST15. In the step ST15, based on present date and time information and the above check end date and time, the date and time for the HDD 20, at which the check processing to be carried out the next time is set as a subsequent check date and time, and stored as data in the nonvolatile memory, etc., incorporated in the apparatus.

It is assumed that the subsequent check date and time is set in the apparatus in advance. Preferably, they should be set to a date and time at which the apparatus will not be used, since the check processing is started when the power supply to the apparatus is in the OFF state or waiting state. Furthermore, the intervals at which the check processing is performed and the time at which the check processing is started are set in advance in the apparatus; however, they may be arbitrarily set by the user.

In the step ST15, after setting the subsequent check date and time for checking the HDD 20, the step to be carried out proceeds to the step ST16 to end the check processing for the HDD 20.

The abnormality detection flag is managed by the flag management section 35a2 shown in FIG. 2. The subsequent check date and time is managed by the check time management section 35a3.

Next, a method of informing the user of the result of the check processing for the HDD 20 in the apparatus (the digital television broadcast receiver or recorder) after the check processing ends will be explained.

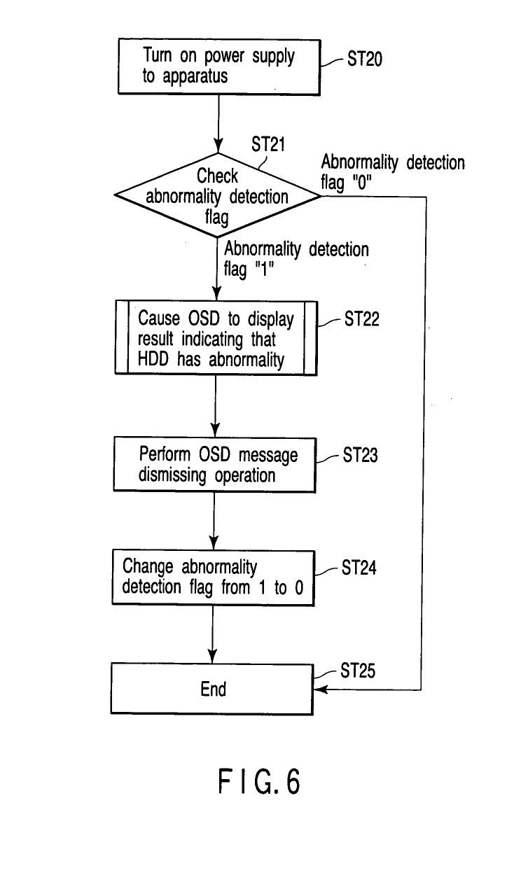

FIG. 6 is a flowchart disclosing the outline of a method of informing the user in advance that the HDD 20 is likely to fail, after the check processing for the HDD 20 ends as shown in FIG. 5.

After the HDD 20 is checked, the power supply to the apparatus is in the OFF or waiting state. Then, in a step ST20, when the power supply to the apparatus is turned on, an indication processing for informing the user of the result of the check processing for the HDD 20 can be started. After the power supply to the apparatus is turned on, the step to be carried out proceeds to the step ST21, a flag check processing for checking the abnormality detection flag set in the step ST14a or step ST14b shown in FIG. 5 is performed.

When the abnormality detection flag indicates 0, it means that the HDD 20 has no abnormality, and thus the step to be carried out proceeds to a step ST25 to end the above series of processings. When the abnormality detection flag indicates 1, the step proceeds to a step ST22, in which the result of the check processing for the HDD 20 is displayed by using the on-screen display (OSD), as a result of which the user can know the result of the check processing for the HDD 20.

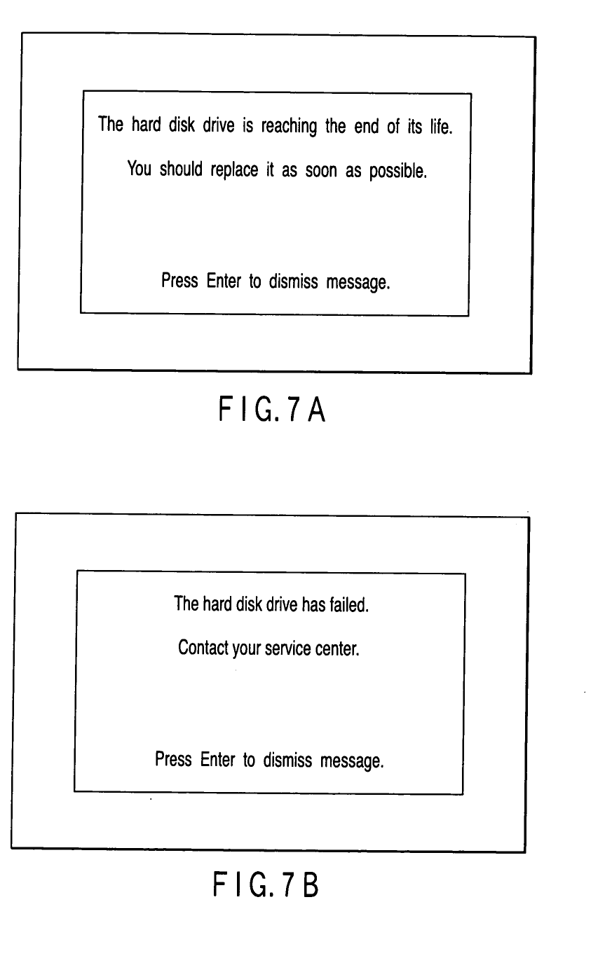

FIG. 7A shows an example of a message on the display, which can be displayed by a display signal processing of the OSD processing section 35b1. FIG. 7B shows an example of a message on the display, which is displayed when an abnormality is detected in the HDD 20.

In a conventional apparatus, when the user operates the HDD for recording/reproduction, and then the HDD fails completely, a message like that shown in FIG. 7B is displayed to prompt the user to send the apparatus to a service center or similar facility for repair. That is, until this time, the user does not know whether the HDD needs repair or not.

In the present invention, the HDD is periodically checked in advance with respect to whether it is likely to fail or not as explained above. Thus, a message like that shown in FIG. 7A can be displayed in advance, and the user can know that the HDD needs repair, before the HDD can fail. That is, the user can have the apparatus repaired before accessing the HDD. Furthermore, it should be noted that it is explained that the OSD is used as the display serving as means for informing the user that the HDD has an abnormality. However, such an information operation may be performed by using a display such as an LED, etc., provided at the main body, instead of the OSD. Also, the display such as the LED, etc. and the OSD may be used in combination.

When the OSD message in the step ST22 is continuously displayed to interfere with viewing, the user can dismiss it with, for instance, a remote control (step ST23 in FIG. 6).

The message displayed in the step ST22 has sufficiently played its part at that point in time when it is displayed. That is, it interferes with viewing if it is continuously displayed. Thus, it can be dismissed with the remote control operable by the user as shown in FIG. 7A (it can be dismissed by using a button on the remote control in the example shown in FIG. 7A).

After the above dismissing operation for dismissing the OSD message, in a step ST24, the abnormality detection flag is set to 0 in order to prevent the message from being re-displayed by the OSD when the power supply is turned on/off. After the processing in the step ST24 ends, the step to be carried out proceeds to the step ST25, ending the above series of processings.

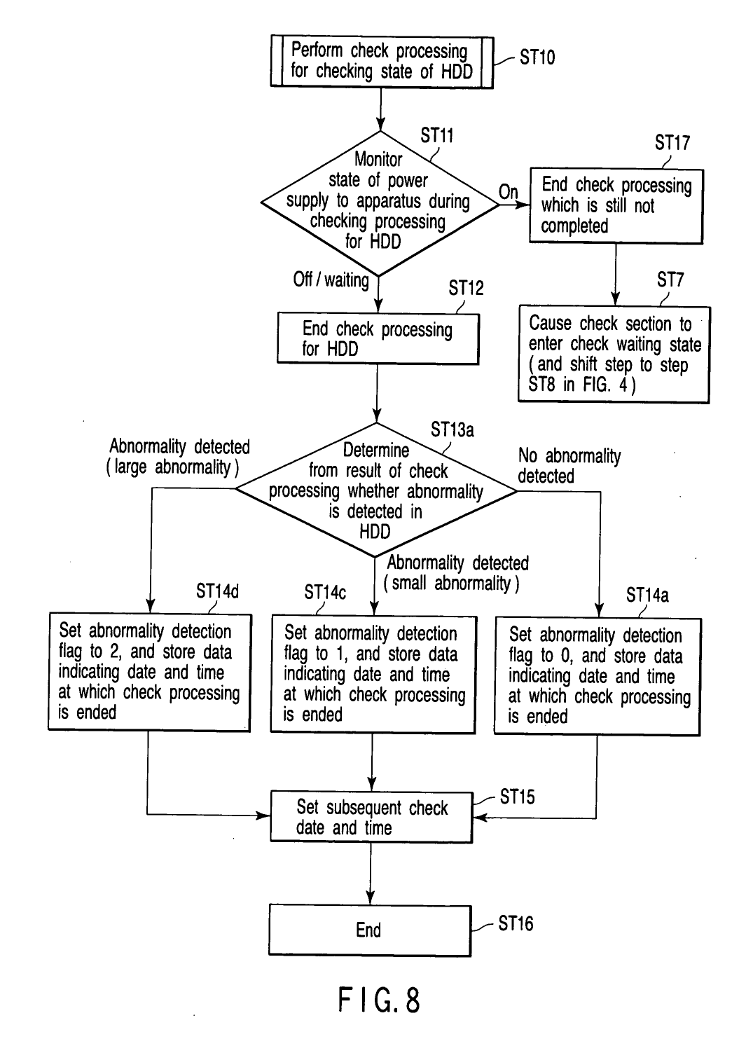

Next, a modification of the above embodiment will be explained with reference to FIG. 8.

In the modification, part of the method of carrying out the check processing for the HDD as shown in FIG. 5 and part of the indication processing for informing the user of the result of the check processing as shown in FIG. 5 are modified.

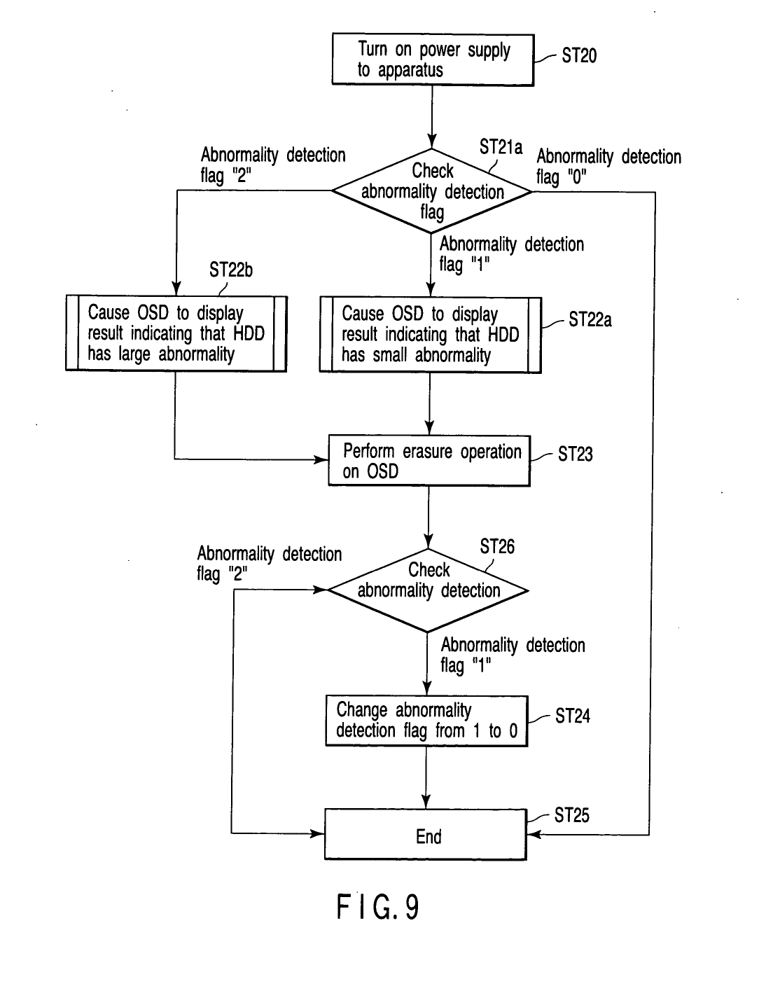

FIG. 8 is a flowchart showing the outline of the method of carrying out the check processing for the HDD in the modification. FIG. 9 is a flowchart showing an indication method of informing the user of the result of the check processing for the HDD in the modification. With respect to the modification, the same structural elements and steps as in the above embodiment are respectively denoted by the same reference numerals as in the embodiment.

The flowchart of FIG. 8 is different from that in FIG. 5 in the following point: in checking the result of the check processing for the HDD in the step ST13a, processing to be executed in the case where the HDD has an abnormality is divided into two processings which are to be applied to respective cases where the abnormality is small, and where the abnormality is large. That is, the degree of the abnormality is checked.

It is determined that the abnormality of the HDD is small, and the step to be carried out proceeds to a step ST14c, when it is determined from the result of the checking that the HDD itself may not completely fail; however, there is a possibility that video may not be correctly or appropriately recorded or reproduced, since a value determined from the number of times the SMART function is retried and the number of abnormal sectors, etc. exceeds a threshold value. In the step ST14c, the abnormality detection flag is set to 1, the checking stop time is stored as data, and the step to be carried out proceeds to the step ST15. Furthermore, in checking the result of the check processing for the HDD in the step ST13a, the remaining life of the HDD is estimated from data regarding the total time for which the power supply is in the ON state, the CSS frequency and the temperature, etc. In addition to the above estimation of the remaining life of the HDD, in consideration of the degree of the degradation of the HDD based on the Read/Write error rate, when it is determined that the HDD will fail completely unless it is replaced by a new one, it is determined that the abnormality of the HDD is large, and the step to be carried out proceeds to a step ST14d. In the step ST14d, the abnormality detection flag is set to 2, and the checking stop time is stored as data, and the step to be carried out proceeds to the step ST15.

In the step ST15, present date and time information and the subsequent check date and time at which the check processing is to be executed are set based on the above check end date and time as in the case shown in FIG. 5, and are stored as data in the nonvolatile memory, etc. in the apparatus. After the subsequent check date and time are set in the step ST15, the step to be carried out proceeds to the step ST16 to end the check processing for the HDD.

Next, with respect to the modification, the method of informing the user of the result of the check processing for the HDD will be explained. FIG. 9 is a flowchart showing a method of informing in advance the user that the HDD is likely to fail, after the result of the check processing for the HDD, shown in FIG. 8, ends. The flowchart of the FIG. 9 is different from that of FIG. 6 in the following point: in checking the abnormality detection flag in a step ST21a, the abnormality detection flag can indicate “0”, “1” and “2”, and the following processings are thus different from the processings in FIG. 6.

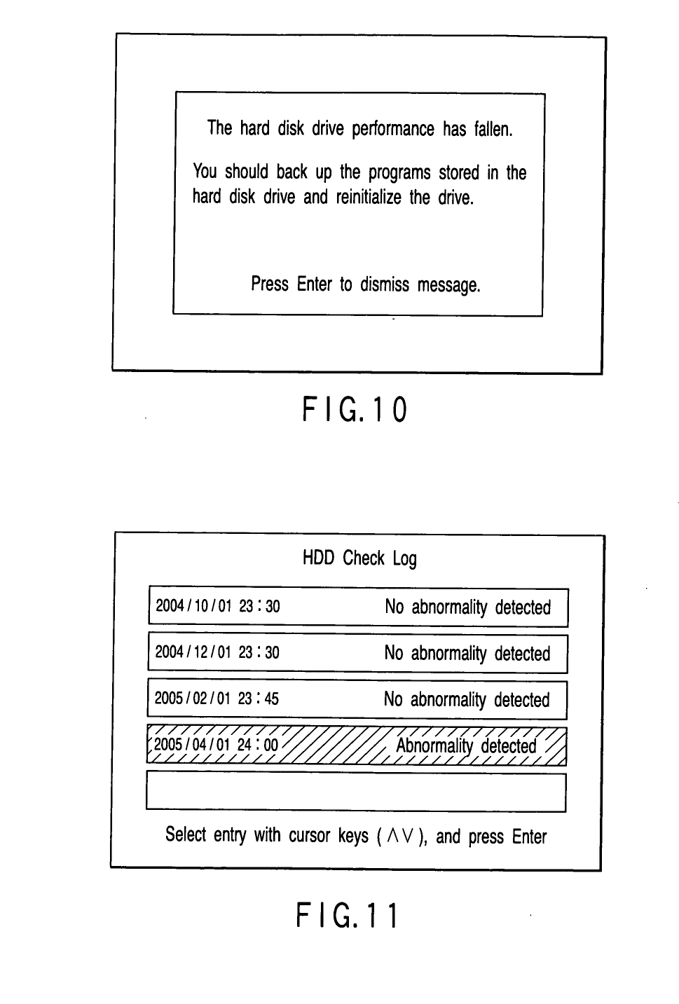

In checking the abnormality detection flag in the step ST21a, when the abnormality detection flag indicates 1, the step to be carried out proceeds to a step ST22a, and when the abnormality detection flag indicates 2, the step proceeds to a step ST22b. That is, the message to be displayed on the OSD for the user varies in accordance with which of the above numbers is indicated by the abnormality detection flag. To be more specific, when the abnormality detection flag indicates 1, it is determined as the result of the check processing for the HDD that the abnormality of the HDD is small, as explained above with reference to FIG. 8. Thus, a message like that shown in FIG. 10 is displayed to suggest that the HDD itself does not need to be replaced, but processing for improving the recording/reproducing operation be carried out. On the other hand, when the abnormality detection flag indicates 2, it is determined as the result of the check processing for the HDD that the abnormality of the HDD is large as explained above with reference to FIG. 8, a message like that shown in FIG. 7A is displayed to suggest that the HDD be replaced.

If the message displayed in each of the steps ST22a and ST22b is continuously displayed, it interferes with viewing for the user as explained above with reference to FIG. 6, and can thus be dismissed with the remote control, etc, by the user (e.g., the message shown in each of FIGS. 7A and 10 can be dismissed by using a button on the remote control, etc.).

After dismissing the OSD message, the step to be carried out proceeds to a step ST26, and the above abnormality detection flag check processing is carried out. In this case, when the abnormality detection flag indicates 1, the step to be carried out proceeds to the step ST24, the abnormality detection flat is set to 0, and the step proceeds to the step ST25, ending the above series of processings. When the abnormality flag detection flag indicates 2, it remains unchanged, and the step to be carried out proceeds to the step ST25, ending the above series of processings.

To be more specific, in the case where the abnormality detection flag indicates 1, as shown in the step ST22a and FIG. 10, the degree of the abnormality of the HDD is small. Therefore, after the OSD message is dismissed, it does not need to be displayed each time the power supply is re-turned on. That is, the above processing is intended to prevent the OSD message from being re-displayed.

On the other hand, when the abnormality detection flag indicates 2, there is a possibility that the HDD may fail completely before long. Thus, the abnormality detection flag remains unchanged, and a message for prompting the user to replace the HDD as soon as possible is displayed each time the power supply is turned on.

In such a manner, the message is displayed on the OSD when the power supply is turned on. Furthermore, the result of detection which is indicated in the step ST14a, ST14c or ST14d, may be stored as data, along with the check end date and time at which checking of the HDD was ended, in the nonvolatile memory, etc, and be set confirmable at any time as a check history (check log).

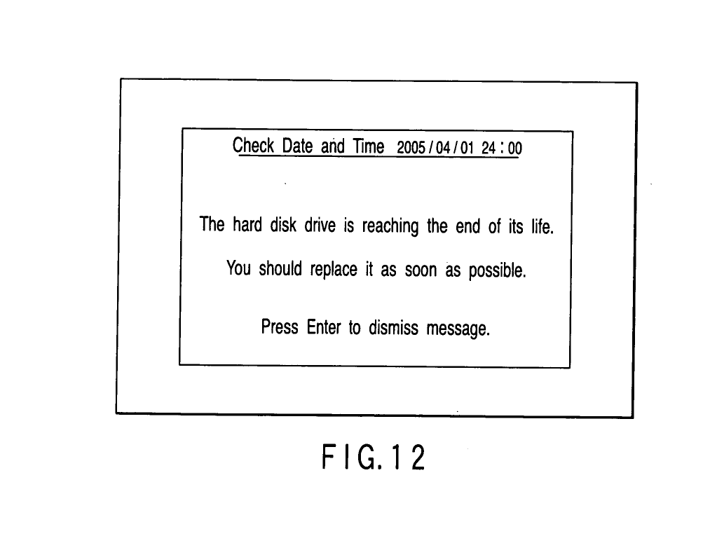

This function can be easily achieved by adding such a display function as shown in FIGS. 11 and 12 to a menu function which enables the recorder to be variously set.

In such a manner, when it is determined as the result of the check processing for the HDD that an abnormality is detected, the contents of the abnormality are analyzed and classified, and the message regarding the abnormality is displayed on the OSD in accordance with the result of the above analysis. Thus, a more appropriate processing method can be provided to the user.

In a conventional recorder provided with an HDD, the user cannot know that the HDD needs to be replaced until the HDD fails completely. In general, the user cannot replace it, and thus asks a serviceman to do so. Inevitably, it takes long time. Thus, the user cannot use the recorder for long time. This is very inconvenient. Furthermore, recent HDDs have been made to have a larger capacity. Therefore, the user can have a larger number of television programs recorded in the HDD. However, even if a large number of television programs are recorded in the HDD, when the HDD fails, the user cannot view all those programs for long time. On the other hand, in the present invention, the HDD is periodically and automatically checked to estimate whether or not the HDD may fail. Thus, the user can be informed that the HDD needs to be replaced, before the HDD fails completely.

Moreover, recently, apparatuses which enable the user to replace the HDD have been developed and provided. When the present invention is applied to such an apparatus, it is possible to easily inform the user of the time at which the HDD is to be replaced. Furthermore, when the result of the check processing for the HDD is indicated in more detail, the user can more accurately or appropriately know the state of the HDD.

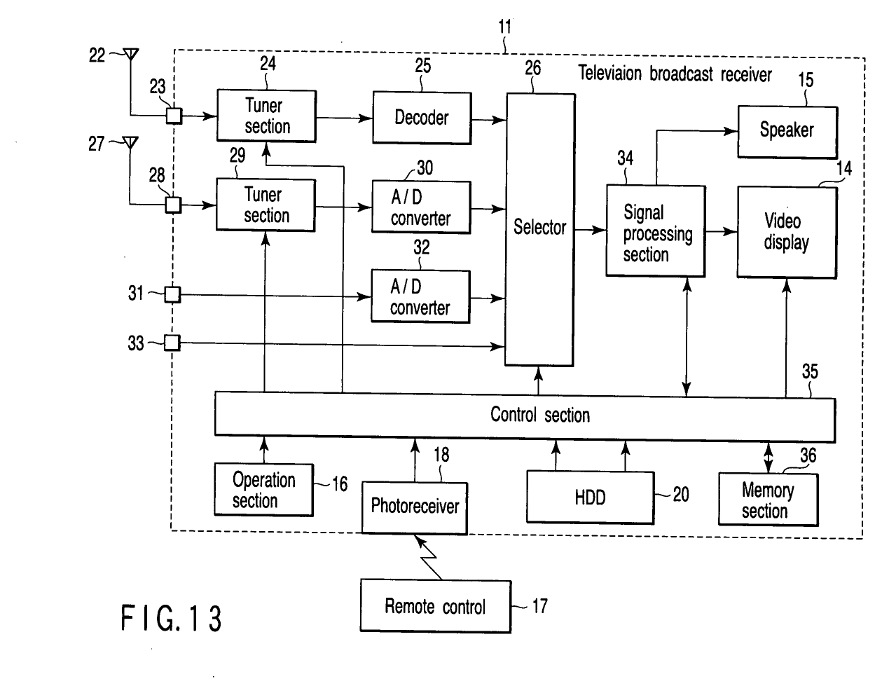

It should be noted that FIG. 2 shows that the signal processing system of the televisions broadcast receiver 11 is divided into the main body side and the stand side; however, it need not be divided in such a manner. For example, the main body side and the stand side may be combined together as in the case shown in FIG. 13, wherein the television broadcast receiver 11 incorporates the HDD 20.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A video display processing apparatus comprising:
a reception section which receives a video signal;
a signal processing section which subjects a predetermined signal processing to the video signal received by the reception section;
a video display section which displays video in accordance with the video signal subjected to the predetermined signal processing by the signal processing section;
a recording/reproducing device which records as data an output signal from the signal processing section;
a checking section which subjects the recording/reproducing device to a check processing with respect to a plurality of failure factors;
a recording/reproducing management section which causes the recording/reproducing device to start recording/reproducing information or readies the recording/reproducing device to start recording/reproducing the information;
a check waiting control section which causes the checking section to wait for the check processing, when the recording/reproducing management section causes the recording/reproducing device to start recording/reproducing the information or readies the recording/reproducing device to start recording/reproducing the information before the checking section starts the check processing;
a checking start control section which causes the checking section to start the check processing, when the recording/reproducing management section does not cause the recording/reproducing device to start recording/reproducing the information or ready the recording/reproducing device to start recording/reproducing the information before the checking section starts the check processing; and
a check result indication section which causes the video display section to display a result of the check processing.

2. The video display processing apparatus according to claim 1, wherein the checking section includes a management section which sets a subsequent date and time at which the check processing is to be performed.

3. The video display processing apparatus according to claim 1, wherein the checking section includes a management section which stores information indicating the result of the check processing and information indicating a date and time at which the check processing was performed.

4. The video display processing apparatus according to claim 1, wherein the result of the check processing is stored as data in the checking section, and the check result indication section causes the video display section to display the result of the check processing stored in the checking section, when a power supply is turned on.

5. The video display processing apparatus according to claim 1, wherein after the checking start control section causes the checking section to start the check processing, when the recording/reproducing management section causes the recording/reproducing device to start recording/reproducing the information or readies the recording/reproducing device to start recording/reproducing the information, the check waiting control section causes the checking section to stop and wait for the check processing.

6. The video display processing apparatus according to claim 1, wherein the check result indication section causes the video display section to display the result of the check processing in such a way as to indicate a degree of an abnormality, when the checking section ends the check processing.

7. The video display processing apparatus according to claim 1, wherein the result of the check processing is stored as data in the checking section, and the check result indication section causes the video display section to display the result of the check processing stored in the checking section in such a way as to indicate a degree of an abnormality, when a power supply is turned on.

8. A method of checking a recording/reproducing device in response to a command from a control section, the method being applied under a condition wherein there are provided: a reception section which receives a video signal; a signal processing section which subjects a predetermined signal processing to the video signal received by the reception section; a video display section which displays video in accordance with the video signal subjected to the predetermined signal processing by the signal processing section; a recording/reproducing device which records as data an output signal from the signal processing section; a checking section which subjects the recording/reproducing device to a check processing with respect to a plurality of failure factors; and a recording/reproducing management section which causes the recording/reproducing device to start recording/reproducing information or readies the recording/reproducing device to start recording/reproducing the information, the method comprising:
causing the checking section to wait for the check processing, when the recording/reproducing management section causes the recording/reproducing device to start recording/reproducing the information or readies the recording/reproducing device to start recording/reproducing the information before the checking section starts the check processing;
causing the checking section to start the check processing, when the recording/reproducing management section does not cause the recording/reproducing device to start recording/reproducing the information or ready the recording/reproducing device to start recording/reproducing the information before the checking section starts the check processing; and
causing the video display section to display a result of the check processing.

9. The method according to claim 8, wherein after the check processing ends, a subsequent date and time at which the check processing is to be performed is set.

10. The method according to claim 8, wherein information indicating the result of the check processing and information indicating a date and time at which the check processing was performed are stored in the checking section.

11. The method according to claim 8, wherein the result of the check processing is stored as data in the checking section, and the video display section is caused to display the result of the check processing stored in the checking section, when a power supply is turned on.

12. The method according to claim 8, wherein after the checking section starts the check processing, when the recording/reproducing management section causes the recording/reproducing device to start recording/reproducing the information or readies the recording/reproducing device to start recording/reproducing the information, the checking section is caused to stop the check processing.

13. The method according to claim 8, wherein the video display section is caused to display the result of the check processing in such a way as to indicate a degree of an abnormality, when the checking section ends the check processing.

14. The method according to claim 8, wherein the result of the check processing is stored as data in the checking section, and the video display section is caused to display the result of the check processing stored in the checking section in such a way as to indicate a degree of an abnormality, when a power supply is turned on.
